(19) United States
(12) Patent Application Publication
(10) Pub. No.: US 2016/0078422 A1
(43) Pub. Date: Mar. 17, 2016

(54) SYSTEM AND METHOD FOR ENHANCING RFID TAGGED PRODUCTS IN PACKAGES WITH MULTIPLE PRODUCTS

(71) Applicants: David Holmes, La Center, WA (US); Mathew Smith, Antibes (FR)

(72) Inventors: David Holmes, La Center, WA (US); Mathew Smith, Antibes (FR)

(21) Appl. No.: 14/849,906

(22) Filed: Sep. 10, 2015

Related U.S. Application Data
(60) Provisional application No. 62/049,971, filed on Sep. 12, 2014.

(51) Int. Cl. G06Q 20/20; G06Q 30/04; G06Q 20/10; G07G 1/00

(52) U.S. Cl. CPC G06Q 20/20; G07G 1/0054; G07G 1/009; G06Q 30/04; G06Q 20/102

(57) ABSTRACT

A multi-product-package POS (point of sale) enhancement system for enhancing software features in products at the POS. The system comprising a register and a multi-product contactless POS read/write terminal at a retail location and a central server at a remote location. The register configured for identifying one or more products in a package, indicating one or more enhancements available for the product(s), and receiving indication of a selected enhancement(s) from the customer. The multi-product contactless POS read/write terminal is in communication with the register and configured for receiving one or more PEA (product enhancement authorization) tokens for the selected enhancement(s), validating the PEA token(s) and executing the enhancement(s) of each product via an RFID tag coupled to the product, generating an audit record of the enhancement(s) of the product(s), and sending the audit record from the contactless POS terminal to the central server.

### CROSS-REFERENCE TO RELATED APPLICATION

This application claims the benefit of U.S. Provisional Application No. 62049971, filed 2015Sep. 12, incorporated herein by reference.

### FIELD OF THE INVENTION

The present invention relates to the field of POS (point of sale) terminals with contactless capabilities, specifically with RFID (radio frequency identification) or NFC (near field communication) capabilities.

### BACKGROUND

A recent innovation in the video gaming industry has created a market for RFID enabled products, particularly toy figures. These toys are RFID enabled by having an RFID/NFC tag embedded in them. Examples of games employing these features are Skylander®, from Activision®, and Disney Infinity®. The RFID enabled toys are used with a contactless/RFID/NFC reader connected to a video game console (such as a Sony Playstation® or a Microsoft XBox™) by a cable or wireless connection that can read the RFID tags on the toys. The RFID tags have data relating to the physical toy encoded on them. When an RFID enabled toy is placed on the connected reader, the reader reads the toy's RFID tag and the console identifies the toy and incorporates the virtual character associated with the toy into the game.

When playing the game on the console with a particular character, the character may gain additional attributes (‘powers’, ‘weapons’, ‘game items’, etc.). This information is recorded by the console via the reader on the RFID tag in the toy. Special cryptographic keys are required by the game console to write to the RFID tag since the specific features of the tag include read and write protection that are controlled by these cryptographic keys. When the procedure is carried out the toy can be said to be ‘upgraded’ or ‘enhanced.’ In current usage, this enhancement is carried out only via the console and its connected contactless/RFID/NFC reader.

There are advantages to having the product enhanced at the point of sale. Retailers can expand the types of products offered while reducing the number and types of product stocked. Also, the point of sale is an opportunity to up-sell the customer for added features. What is needed is a way for product manufactures to design products such that customers may purchase enhancements for a physical product (such as an RFID enabled toy) at the same time they purchase the product from a retail store and then have the product enhanced at the store. Products such as NFC/RFID video game toys are often sold in packs of more than one item. What is further needed is a way to enhance products that come in packages with multiple enhanceable products in a single package.

### SUMMARY

Embodiments of a point-of-sale (POS) product enhancement system for the secure and controlled creation of enhanced software features in a multi-product-package at the point of sale (POS) are described herein. The exemplary multi-product-package POS enhancement system comprises at least one register and a multi-product contactless POS read/write terminal operated by a retailer at a retail location and a central server operated by the retailer or a central server company on the premises or at a location remote from the retail location. The register is configured for identifying one or more products within a package, indicating any enhancements available for the product(s), receiving indication of any selected enhancements from the customer, adding charges for any selected enhancement(s) to a bill for the customer; and recording payment from the customer for the bill.

Either the register or a back officer server operated by the retailer is configured for generating one or more PEA (product enhancement authorization) token(s) for the selected enhancement(s) and transmitting the PEA token(s) to the multi-product contactless POS read/write terminal.

The contactless read/write terminal is in communication with the register and configured for receiving the PEA token for the selected enhancement(s), validating the PEA token, obtaining instructions for the selected enhancement(s), verifying that the selected enhancement(s) can be executed, indicating readiness to enhance the product(s), detecting the product(s), executing the enhancement(s) of the product(s) via an RFID tag coupled to the product(s), generating an audit record of the enhancement(s) of the product(s), and sending the audit record from the contactless POS terminal to the central server.

The central server is configured for requesting the audit record from the contactless POS terminal, receiving the audit record from the contactless POS terminal, generating an invoice of the enhancement(s) for a retailer operating the register, generating an income statement for a manufacturer of the product, and updating a set of enhancement instructions stored on the contactless POS terminal.

Other embodiments of this aspect include corresponding computer systems, apparatus, and computer programs recorded on one or more computer storage devices, each configured to perform the actions of the methods.

### BRIEF DESCRIPTION OF THE DRAWINGS

The present invention will be described by way of exemplary embodiments, but not limitations, illustrated in the accompanying drawings in which like references denote similar elements, and in which:

The accompanying drawings, which are incorporated into and constitute a part of this specification, illustrate one or more embodiments of the invention and, together with the detailed description, serve to explain the principles and implementations of the invention.

FIG. 1 is a block diagram of retail location components of the exemplary POS multi-product enhancement system.

FIG. 2 is a block diagram of components of an exemplary multi-product contactless POS read/write terminal, part of the product software enhancement system.

FIG. 3 is a block diagram of the exemplary POS multi-product enhancement system, including both retail location components and components typically in locations other than the retail location.

FIG. 4 shows a schematic of the exemplary multi-product contactless POS read/write terminal configured to mate with each of a set of product packages, each package in the set with differing numbers of products therein, each package in the set configured to mate with the exemplary multi-product contactless POS read/write terminal.

FIGS. 5A-5D present a flow chart for a multi-product-package POS enhancement method using the multi-product-package POS enhancement system.

### DETAILED DESCRIPTION

Before beginning a detailed description of the subject invention, mention of the following is in order. When appropriate, like reference materials and characters are used to designate identical, corresponding, or similar components in different figures. The figures associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application and business related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

Use of directional terms such as “upper,” “lower,” “above,” “below”, “in front of,” “behind,” etc. are intended to describe the positions and/or orientations of various components of the invention relative to one another as shown in the various Figures and are not intended to impose limitations on any position and/or orientation of any embodiment of the invention relative to any reference point external to the reference.

Those skilled in the art will recognize that numerous modifications and changes may be made to the exemplary embodiment(s) without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the exemplary embodiment(s) is essential. Other embodiments are possible, their specific designs depending upon the particular application. As such, the scope of the invention should not be limited by the particular embodiments herein described but should be defined only by the appended claims and equivalents thereof.

### Point f Sale (POS) Product Enhancement-Overview

Enhancements take time and effort to achieve in the gaming context and as such are valuable to gamers. It is advantageous for product manufactures to design products such that customers may purchase enhancements for a product (such as an RFID enabled toy) at the same time they purchase the physical product from a retail store and then have the product enhanced at the store. The inventors describe such a system and process in a related and separately filed patent application: “System and Method for Point of Sale Product Software Enhancement.”

However, the exemplary POS product enhancement system and associated method described therein only enhance a single product at a time at a point of sale terminal. Products such as NFC/RFID video game toys are often sold in packs of more than one item. When enhancing a single toy in its retail packaging the single RFID tag in the package needs to be placed over an antenna in the contactless POS read/write terminal and the terminal performs the enhancement. The cashier can be trained to know where the RFID tag is located in the package and so can place it accordingly over the antenna. The contactless POS read/write terminal will notify that the enhancement is complete and the cashier can complete the transaction.

In the case of multiple toys in a single package this becomes more difficult. When a package contains more than one product, several with embedded RFID tags, it becomes extremely difficult to identify which product within the packaging is capable of or designated to get an enhancement. Then, if this is achieved, placing the correct product over the antenna at the correct time for the enhancement to be applied for the number of specific times that the individual enhancements need to be applied can prove to be difficult and is ripe for errors.

### Multi-Product-Package POS Enhancement-System

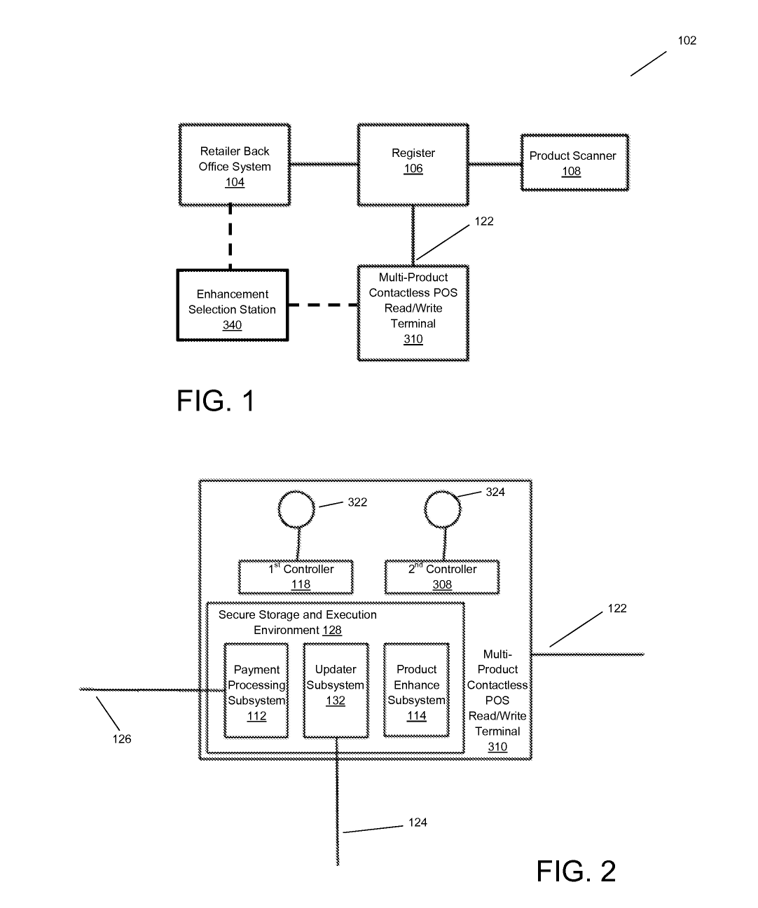

FIGS. 1-3 show an exemplary embodiment of an exemplary POS multi-product enhancement system 300 and its components for the secure and controlled creation of enhanced software features in products at the point of sale (POS). This system is almost identical to the system described in the related patent application previously mentioned, except for the changes noted herein. The exemplary POS multi-product enhancement system 300 has components for the control, recording and transaction handling and settlement mechanisms for individual transactions between customers, retailers, product manufacturers and for the management of exemplary POS multi-product enhancement system 300 as a whole.

FIG. 1 is a block diagram of retail location components 102 of the exemplary POS multi-product enhancement system 300. At the retail location, the exemplary POS multi-product enhancement system 300 has at least one register 106 and is typically connected to a retailer back office system 104 for tracking sales and inventory. The register 106 is a device configured for recording transactions at the point-of-sale. The register 106 is often colloquially called a “cash” register, even if it primarily handles cashless transactions. The register 106 is typically connected to a product scanner 108 for identifying products to be purchased, such as a barcode scanner or QR code scanner. The register 106 may have other inputs that can be used for identifying products, such as manually entering a product code, such an SKU, via a keyboard. The retail location also has a multi-product contactless POS read/write terminal 310 connected to the register 106 with a local connection 122 that may be wireline or wireless. The contactless POS read/write terminal 110 may be used for entering payment information. In the exemplary POS multi-product enhancement system 300, the multi-product contactless POS read/write terminal 310 is also used to enhance the software of products. Enhancing the software of products may include upgrading the software to a new version; adding additional software modules; or enabling features previously disabled.

FIG. 2 is a block diagram of components of the multi-product contactless POS read/write terminal 310. The multi-product contactless POS read/write terminal 310 of the exemplary embodiment has at least a first antenna 322 coupled with a first interface controller 118 and a second antenna 324 coupled with a second interface controller 308, but may have additional antennas (see FIG. 4). The plurality of antennas (322, 324) are configured for short range wireless electronic communication with NFC compatible RFID tags compliant to the ISO 14443 standards, though in other embodiments, another standard may be used. The multi-product contactless POS read/write terminal 310 has several software modules in a secure storage and execution environment 128, including, a payment processing subsystem 112, a product enhancement subsystem 114, and an updater subsystem 132.

The product enhancement subsystem 114 is configured for storing and controlling its own cryptographic keys and for executing enhancements on RFID tags. The product enhancement subsystem 114 has a Product Enhancement Definition Table, which is a database that contains instructions and procedures for enhancements available to it, organized by predefined Product Type IDs (typically a SKU) and Product Enhancement Reference IDs. The Product Enhancement Definition Table includes instructions for executing an enhancement or configuring the feature or features associated with the Product Type ID.

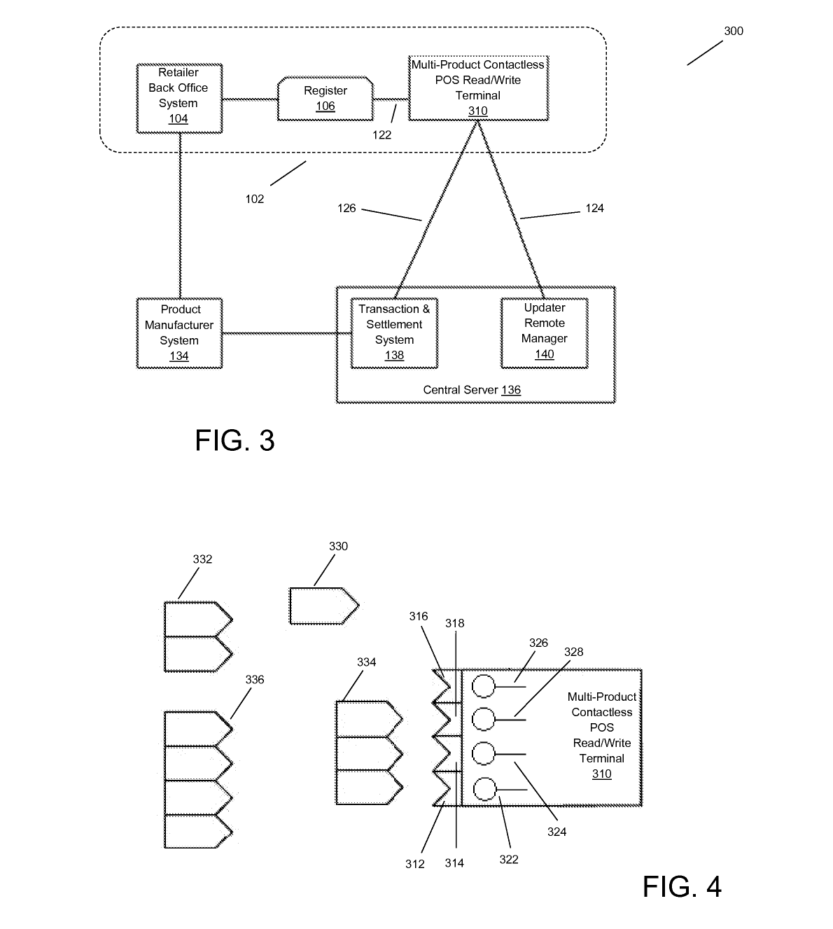

FIG. 3 is a block diagram of the exemplary POS multi-product enhancement system 300, including both retail location components 102 and components typically in locations other than the retail location. In addition to the retail location components 102, the exemplary POS multi-product enhancement system 300 has a central server 136. The central server 136 has a first network connection 124 and a second network connection 126 to the multi-product contactless POS read/write terminal 310. The central server 136 is operated by an entity referred to herein as the “Central Server Operating Company.” The Central Server Operating Company is typically a different entity than the entity that operates the retail location components 102. For simplicity, only one set of retail location components 102 are shown, but typically, the Central Server Operating Company will serve many different retail companies, each with different retail locations and some companies with multiple retail locations, so the central server 136 will typically serve multiple retail locations, each having a set of retail location components 102. In some embodiments the central server 136 is a single physical device, but in other embodiments, it is comprised of several physical devices that may not even be at the same location, but are interconnected and operate in a coordinated fashion.

The central server 136 has software components that it stores and executes, including a transaction & settlement system 138, and an updater remote manager 140. The transaction & settlement system 138 handles the accounting of transactions relating to product enhancements. The transaction & settlement system 138 has a network connection to one or more product manufacturer systems 134 to facilitate exchange of information relating to sales of product enhancements. The updater remote manager 140 is configured to manage the provisioning of multi-product contactless POS read/write terminals 310 at various retail locations, providing new enhancements and otherwise ensuring the multi-product contactless POS read/write terminals 310 have the correct and current enhancement data and installation instructions.

For each retail location, the updater remote manager 140 has access to the multi-product contactless POS read/write terminal 310 via a first network connection 124. The first network connection 124 may need to traverse firewalls of the retailer and other network providers involved. One of the main updates involved is the addition and removal of information regarding availability of enhancement(s) per product type. Another update is the addition and removal of product enhancement instructions in the Product Enhancement Definition Table.

A Product Enhancement Definition Table in a multi-product contactless POS read/write terminal 310 needs updating when a new product enhancement is defined and available in the retail context, when a product enhancement needs to be changed for any reason, or when the product enhancement needs to be removed from the table. The updater remote manager 140 performs this role using the first network connection 124 and encrypts all traffic and payload to ensure that the product enhancement instructions remain secret at all times.

### Multi-Product Contactless POS Read/Write Terminal

FIG. 4 shows a schematic of the exemplary multi-product contactless POS read/write terminal 310 configured to mate with each of a set of conforming product packages, each package in the set with differing numbers of products therein, including a single product package 330, a two product package 332, a three product package 334, and a four product package 336, each of which are configured to mate with the multi-product contactless POS read/write terminal 310. The conforming product packages conform to standard shapes that match physical recesses of the multi-product contactless POS read/write terminal 310 and enable each conforming product package to mate with the exemplary multi-product contactless POS read/write terminal 310 in a specific way.

The physical layout of the multi-product contactless POS read/write terminal 310 is configured so that when one of the conforming product packages is mated to it, the RFID tags embedded in the products inside the packaging will physically line up with the antennas of the multi-product contactless POS read/write terminal 310. The exemplary multi-product contactless POS read/write terminal 310 has 4 antennas, including first antenna 322, a second antenna 324, a third antenna 326 and a fourth antenna 328, though other embodiments may have more than 4 antennas or less than 4. The conforming product packages can contain a number of products up to the maximum of the antennas or read zones in the multi-product contactless POS read/write terminal 310. The conforming product packages may contain products from many different product manufacturers and contain numerous product types. Typically, a conforming product package containing multiple products will have products all from one product manufacturer, but in other instances may not. For example, a retailer may choose to bundle several different types of products from several different product manufacturers.

The multi-product contactless POS read/write terminal 310 is configured such that there is a limited set of correct ways a package can be placed on or inserted into the multi-product contactless POS read/write terminal 310 and configured that other ways will seem obviously wrong to a typical user. Each correct way that a given package can be placed on or inserted into the multi-product contactless POS read/write terminal 310 (herein a ‘correct placement’) ensures all the appropriate RFID tags in a given package are in a position to be read and written to by the multi-product contactless POS read/write terminal 310. Any particular design of multi-product contactless POS read/write terminal 310 and conforming product packages will have a small and finite number of correct placements. In some embodiments, if a conforming product package has a correct placement with regards to the/multi-product contactless POS read/write terminal 310, a visual, audio or other type of indicator is set, signaling that the package has correct placement.

Ensuring a correct placement is easily achieved can be enabled by various embodiments. Conforming product packaging may have physical elements such as lugs, holes, handles, specific combination of angles, recesses, pins, levers, spring loaded sections and similar devices together with their physical complement in the multi-product contactless POS read/write terminal 310. Conforming product packaging can be subject to a design copyright or trademark and thereby incorporated into the product concept.

### Multi-Product-Package POS Enhancement-Method

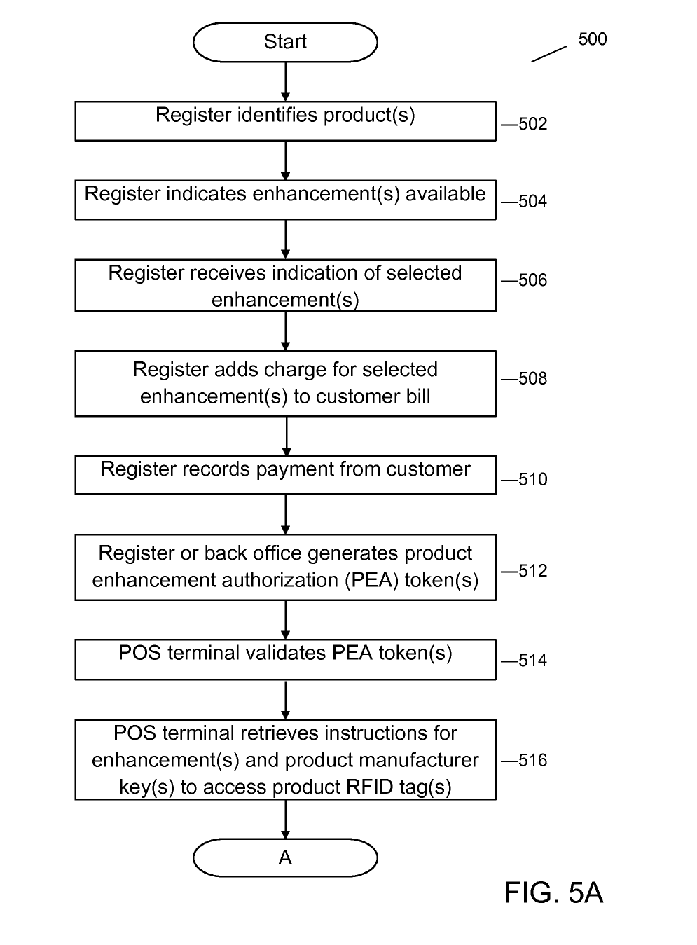

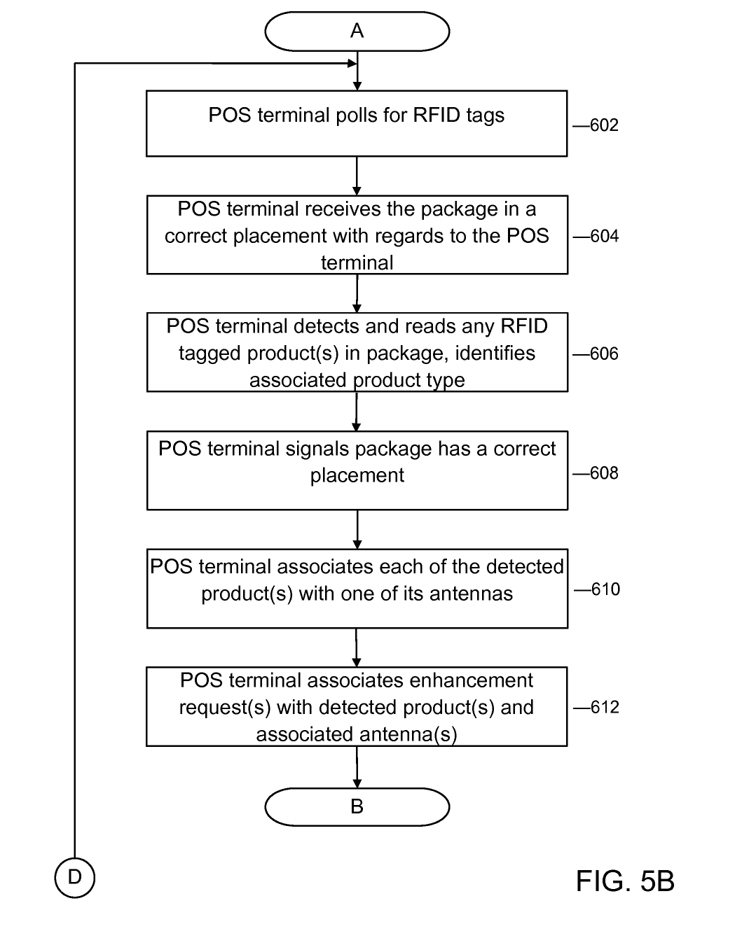

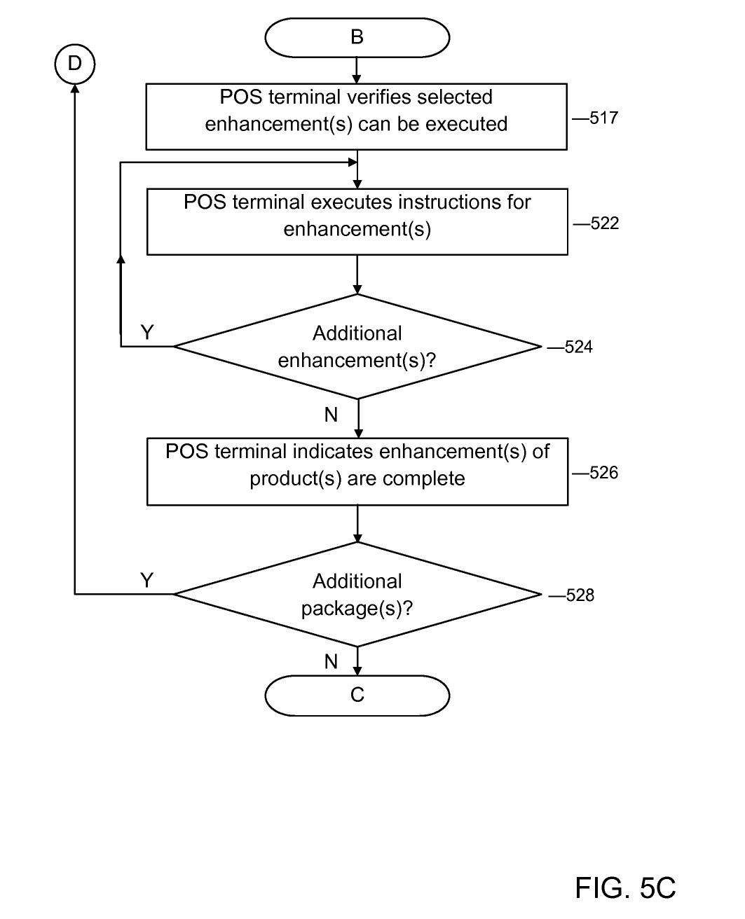

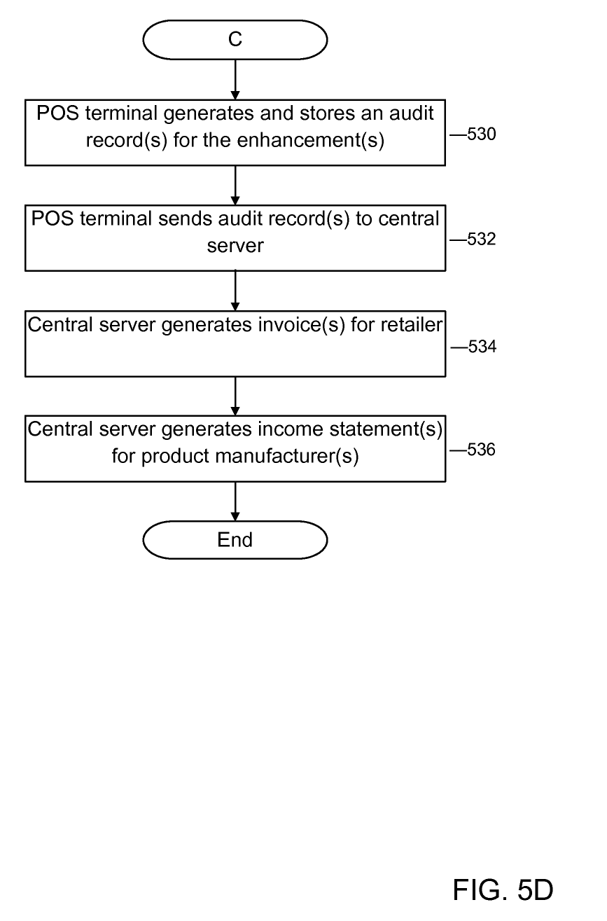

FIGS. 5A-5D present a flow chart for a multi-product-package POS enhancement method 500 using the multi-product-package POS enhancement system 300. This method and system could be used when, for example, a customer wants to buy a package containing one or more product(s) at a retail store and the product(s) each contain an RFID tag with a microprocessor and a memory in which data and software are stored. The product(s) are designed such that their functions depend on the stored software and data. The product(s) may interact with other products either already owned by the customer, owned by some third party (like a set-top box or gaming console) or that the customer will buy in the future. The method begins when the customer presents a package containing the product(s) at the Point of Sale (POS). The register 106 identifies the product(s) in the package (step 502). This may be accomplished by the cashier scanning the product with the product scanner 108 or some other type of scanner or manually entering a product identification code into the register 106. If the customer has additional packages, any products therein may be identified sequentially in the same manner. The register 106 indicates if any of the product(s) identified may be enhanced or upgraded (step 504). Based on this information, the cashier can then offer the customer enhancements such as additional or alternative features and functions for the product.

The register 106 then receives enhancement selection(s) (step 506). The selection of enhancements can be performed by a customer or sales assistant using barcodes (or other codes such as QR codes) on a paper or electronic form to select certain features which are then available. The form is scanned with the product scanner 108 at the POS. Alternatively, the register 106 may present the enhancements available for the product(s) on a screen and the customer or the cashier selects enhancements via some mode of data entry, such as a touch screen or keyboard.

If the customer chooses to buy the enhancement(s) for the product(s), then the register 106 creates the sales item(s) based on predefined Stock Keeping Units (SKUs) at that POS and adds them to the customer bill (step 508). The customer pays as normal for a POS transaction and the register 106 records the payment (step 510).

Once the payment is completed, the register 106 (or the retailer back office system 104 for the retailer) then generates an authorization token called Product Creation Approval (PEA) (step 512). In the exemplary embodiment, a separate PEA token is generated for each SKU, but in other embodiments, a single PEA token is generated for the entire customer bill which may contain multiple SKUs, in which case the data structure of the PEA token as described herein is modified accordingly. The PEA tokens(s) are sent to the product enhancement subsystem 114 in the multi-product contactless POS read/write terminal 310. In the exemplary embodiment, any product enhancement(s) must be paid for prior to the PEA token(s) being generated. However, in other embodiments, the PEA token(s) may be generated before payment has been completed.

A PEA token is a cryptographic certificate containing a signed enhancement instruction based on the retailer's cryptographic keys and is a one-time certification to authorize enhancement(s) of one or more product(s). The PEA token is a cryptographically signed data package such as defined in PKCS#1 or Digital Signature Standard (DSS)/Digital Signature Algorithm (DSA) Federal Information Processing Standard (FIPS-PUB-186). The PEA token contains instructions regarding the product enhancement(s) to be performed, and serves as an authentication, authorization, audit and nonrepudiation mechanism.

The PEA token contains information regarding the product enhancement(s) to be performed. This includes but is not limited to the Stock Keeping Unit of the package (or other identifier for the package), the list of Product Type References, the set of Product Enhancement IDs to apply to each product type. An example of the data set inside the PEA is as follows (but not limited to):
PEA Reference (a unique identifier for the PEA)
Date/Time stamp for the PEA creation
Package SKU (a unique identifier for the package)
Payment Reference (unique identifier linking to the payment information for the product enhancements)
A set of (one for each product enhancement):
   A Product Type Reference (a unique reference identifying the particular type of product e.g. a particular toy or figurine);
   A Product Item Unique Identifier, in the case where there are multiple items of the same Product Type Reference (this is optional and if there is only one instance of the product type in the package, it is not needed, though may be included for completeness); and
   A Product Enhancement Reference (a unique reference identifying the actual product enhancement transaction)

Additional data may be included in a PEA token and can include but are not limited to, Retailer Reference, Store Reference, Register Details, Cashier Reference, and other transactional information.

The product enhancement subsystem 114 of the multi-product contactless POS read/write terminal 310 then validates the PEA token(s) using a private key (step 514). Once validated, the product enhancement subsystem 114 obtains a series of instructions to execute the enhancement requested in the PEA token(s) and typically a product manufacturer key, a separate cryptographic key issued by the product manufacturer that permits write access to the product RFID tag (step 516).

The product enhancement subsystem 114 obtains the instructions for the requested enhancement(s) from the Product Enhancement Definition Table, which is stored in the secure storage and execution environment 128 inside the multi-product contactless POS read/write terminal 310. The Product Enhancement Definition Table stores the specific detailed instructions for each product type that can be enhanced or upgraded. The instructions may be in the form of a script definition that is parsed inside the multi-product contactless POS read/write terminal 310, or in the form of stored Application Protocol Data Unit (APDU) templates, other forms of instructions may be used in other embodiments. APDUs are the standard method of communicating with ISO 14443 standard RFID tags. The product manufacturer key may be needed to cryptographically sign the APDUs.

The product manufacturer key is stored in a separate part of the secure storage and execution environment 128 inside the multi-product contactless POS read/write terminal 310. The product manufacturer key is usually needed because most product manufacturers protect the RFID tag in their products from unauthorized modification with the product manufacturer key. Typically, the product manufacturer key is used to generate the APDUs. The specific mechanism of cryptographic protection may vary from one product manufacturer to another, but the specific detailed instructions for each product type obtained from the Product Enhancement Definition Table will specify the process for unlocking the RFID tag write protection.

In some embodiments, the ADPUs are generated at the central server 136 and then sent to the multi-product contactless POS read/write terminal 310 in real time following a request from the product enhancement subsystem 114. A further level of encryption would protect this communication.

The multi-product contactless POS read/write terminal 310 polls for RFID tags (step 602) (see FIG. 5B). This polling may be done continuously or at intervals, for the entire time the multi-product contactless POS read/write terminal 310 is energized or for some subset thereof, such as for a certain time after the multi-product contactless POS read/write terminal 310 has received instructions for enhancement(s). A detection algorithm in the product enhancement subsystem 114 detects and reads any RFID tagged product(s) in the package, identifies the product types associated with each detected product (step 606). When a package has a correct placement with regards to the multi-product contactless POS read/write terminal 310 (step 604), the multi-product contactless POS read/write terminal 310 may signal that the package is in a correct placement (step 608). The product enhancement subsystem 114 associates each of the detected product(s) with one of the plurality of antennas (322-338), typically the antenna that detected and read the associated product's RFID tag (step 610).

The multi-product contactless POS read/write terminal 310 prepares the enhancement transaction by associating each enhancement request with the appropriate product and the associated antenna step (612).

The product enhancement subsystem 114, according to the instructions obtained from the Product Enhancement Definition Table verifies that the selected product enhancement(s) for a product type is available and can be executed on the associated detected product(s) (step 517).

The product enhancement subsystem 114 of the multi-product contactless POS read/write terminal 310 then executes the instructions for the enhancement(s) (step 522). The product enhancement subsystem 114 prepares each product enhancement as an execution job for the multi-product contactless POS read/write terminal 310. The product enhancement subsystem 114 performs the execution job(s) preparing the individual APDUs for each product enhancement and then applying them to the product(s). Alternatively, the APDUs can be generated on demand during the product enhancement process.

The product(s) in a package may be enhanced simultaneously since each product detected has an antenna assigned. This may be achieved by a parallel multithreaded implementation of the product enhancement algorithm for each product item to be enhanced, either using prebuilt APDUs or building them on demand. The aim is to complete all writes to the products in as short a time as possible.

Some products may have more than one enhancement selected. After an enhancement has been executed, the product enhancement subsystem 114 then determines if additional enhancements for that product item need to be executed (step 524). If so, then the product enhancement subsystem 114 repeats step 522 for that product.

After all enhancements for the product(s) in that package have been executed, the multi-product contactless POS read/write terminal 310 then indicates the enhancement(s) of the product are complete (step 526). The cashier or customer can then remove the package from the field of the multi-product contactless POS read/write terminal 310. The multi-product contactless POS read/write terminal 310 determines if there were additional packages with products to be enhanced (step 528) as indicated in the PEA token(s). If so, then the multi-product contactless POS read/write terminal 310 repeats steps 602-612 and 517-526.

The product enhancement subsystem 114 then generates an audit record for the enhancement(s) and stores it in a file inside the secure storage and execution environment 128 of the multi-product contactless POS read/write terminal 310 (step 530).

The Audit Record will contain the information from the PCA plus the Unique Identifier (UID) of the products enhanced during the transaction plus date and time of the transaction plus any other additional data regarding the transaction that may be required by the central server company or the retailer.

The multi-product contactless POS read/write terminal 310 is connected via a network connection to a central server 136. The central server 136 periodically polls the multi-product contactless POS read/write terminal 310 and in response, the multi-product contactless POS read/write terminal 310 initiates a transfer of the audit record file(s) to the central server 136 (step 532). In other embodiments, the multi-product contactless POS read/write terminal 310 initiates the transmission of the file itself. All communications between the central server 136 and the multi-product contactless POS read/write terminal 310 are encrypted.

When the central server 136 receives a product enhancement transaction audit record from a multi-product contactless POS read/write terminal 310 it processes the record into its own database. The record then forms part of a settlement process whereby the central server 136 uses commercial contract data regarding pricing and retailer and manufacturer data to generate invoices for the retailers (step 534) and generate income statements for the product manufacturer(s) (step 536). Since the Central Server Operating Company may have entered into multiple agreements between multiple product manufacturers and multiple retailers, it can generate an invoice for each retailer for all the product manufacturers concerned. Payments from the retailers are made to the Central Server Operating Company. Individual product manufacturer income statements are then used by the Central Server Operating Company to pay the individual Manufacturers for the product enhancements performed on their products. Other embodiments may have different invoice, statement, and revenue flows.

Errors and exceptions are handled using a message protocol that gives an indication of an error, such as by displaying an error message on a screen attached to the multi-product contactless POS read/write terminal 310 or the register 106 or by sounding an audio alarm. Such errors and exception may be, but not limited to, unable to write to one or more products, incorrect package or products in the reader for the enhancement requested, or incorrect number of enhancements requested for number of products in package.

### Enhancement Selection Station

In some embodiments, the POS multi-product enhancement system 300 includes an enhancement selection station 340 for interacting with the cashier and/or the customer. The enhancement selection station 340 is one of the retail location components 102 and is either a part of the multi-product contactless POS read/write terminal 310 or is a separate device connected by a wired or wireless communication link. Alternatively, the enhancement selection station 340 may be connected to the back office system 104. In this way, when a package is inserted into the multi-product contactless POS read/write terminal 310, the products detected in the package are displayed by the enhancement selection station 340 on a screen or other type of display. The enhancement selection station 340 has an input mechanism such as a touch screen or a keyboard or other input device, such as a mouse or trackpad. This configuration allows for an interactive selection of enhancements for the product.

For example, the enhancement selection station 340 can be established away from the point of sale so as to reduce the queueing load on the POS itself The enhancement selection station 340 may be configured to display a set of options for each product in the package and configured to allow the customer to scroll through and select the enhancements they wish to purchase at their own pace. When customers make selections the total cost of the purchases is displayed on the screen. Once the customer confirms their wish to buy, this information is transmitted to the register 106 and added to the overall bill for the customer. The customer then pays as normal.

The enhancement selection station 340 can be positioned either by the POS so as to be used during the POS transaction, or elsewhere within the retail location, such as a spot near the POS where the customer can stop and select enhancements prior to proceeding to the POS. This would allow for a more considered selection process and less delay at the POS. In this configuration, the enhancement selection station 340 may also include a product scanner to identify the package SKU. Alternatively the enhancement selection station 340 may identify the SKU of the package from the set of individual Product Type Codes of the package if this is sufficient unique combination, it may be that the Product Type codes are created in such a way this is guaranteed. This product scanner at the enhancement selection station 340 is separate from the product scanner 108 that is connected to the register 106. When a customer completes the enhancement selection process, the enhancement selection station 340 transmits data regarding the enhancement selections to the retailer back office system 104-so that the products and enhancements can be identified during the POS transaction. Alternatively, the enhancement selection station 340 may be configured to print a ticket for the consumer to present to the cashier at the POS, that itself has a 1D/2D bar code, or some other symbols printed on it that represent the enhancement selections. This ticket can then be scanned at the POS by the product scanner 108 connected to the register 106 so that the enhancement selections can be included into the POS transaction.

The enhancement selection station 340 may be configured to detect and recognize a customer identifier to identify the customer, such as a loyalty card or token. In this way the enhancement experience can be customized and tuned for the customer. This may include special options for enhancement possibilities related to their account with the retailer or game publisher/product manufacturer, or special pricing or other promotional or game playing initiative by the retailer or publisher/product manufacturer. The customer identifier can be a separate card from a loyalty program store loyalty card. A token may be a pre-purchased product of the RFID type that has been previously registered by the customer that when read at the enhancement selection station 340 can look up the product in a loyalty database and identify the customer. The customer identifier is then used at the POS by the multi-product contactless POS read/write terminal 310 to look up the enhancement selections associated with that particular customer.

What is claimed is:

1. A point-of-sale product enhancement system comprising:
an enhancement selection station configured for:
identifying one or more products in a package, wherein each of the one or more products has at least one of one or more RFID tags and each of the one or more RFID tags is in at least one of the one or more products,
indicating one or more enhancements available for the one or more products, and
receiving indication of one or more selected enhancements from a customer;
a register in communication with the enhancement selection station and configured for:
adding a charge for the one or more selected enhancements to a bill for the customer, and
recording payment from the customer for the bill; and
a contactless POS terminal in communication with the register, comprising a plurality of antennas and configured for:
receiving one or more product enhancement authorization tokens (one or more PEA tokens) for one or more selected enhancements,
validating the one or more PEA tokens,
receiving the package in a correct placement,
detecting the one or more RFID tags when the package has a correct placement with regards to the contactless POS terminal,
associating each of the RFID tags with an associated product of the one or more products and with an associated antenna of the plurality of antennas, and
executing each of the one or more selected enhancements on the associated product via the associated antenna and an associated RFID tag of the one or more RFID tags.

2. The system of claim 1,
wherein the enhancement selection station is further configured for:
sending the indication of the one or more selected enhancements to the register.

3. The system of claim 1, further comprising
a back office server configured for:
receiving the indication of the one or more selected enhancements from the enhancement selection station, and
sending the indication of the one or more selected enhancements to the register.

4. The system of claim 1,
wherein the enhancement selection station is further configured for:
printing the indication of the one or more selected enhancements on a ticket,
wherein the register is further configured for:
reading the indication of the one or more selected enhancements from the ticket.

5. A method for enhancing products at a POS (point-of-sale), comprising the steps of:
identifying, with a register, one or more products in a package, wherein each of the one or more products has at least one of one or more RFID tags and each of the one or more RFID tags is in at least one of the one or more products;
indicating, with the register, one or more enhancements available for the one or more products;
receiving, with the register, indication of one or more selected enhancements from a customer;
generating one or more product enhancement authorization tokens (one or more PEA tokens) for the one or more selected enhancements;
validating, with contactless POS terminal, the one or more PEA tokens;
detecting, with contactless POS terminal, the one or more RFID tags when the package has a correct placement with regards to the contactless POS terminal;
associating, with the contactless POS terminal, each of the RFID tags with one of the one or more products and with a different one of a plurality of antennas, wherein the plurality of antennas are part of the contactless POS terminal;
executing, with the contactless POS terminal, the one or more enhancements of the one or more products via the plurality of antennas and one or more RFID tags;
generating, with the contactless POS terminal, an audit record of the one or more enhancements of the one or more products; and
sending the audit record from the contactless POS terminal to a central server.

6. The method of claim 5, further comprising the step(s) of:
polling, with the contactless POS terminal, for any RFID tags.

7. The method of claim 5, further comprising the step(s) of:
executing, with the contactless POS terminal, one or more additional enhancements of one or more additional products in one or more additional packages.

8. The method of claim 5,
wherein the generating of the one or more PEA tokens is performed by a back office server.

9. The method of claim 5,
wherein the generating of the one or more PEA tokens is performed by the register.

10. The method of claim 5, further comprising the step(s) of:
adding, with the register, a charge for the one or more selected enhancements to a bill for the customer; and
recording, with the register, a payment from the customer for the bill.

11. The method of claim 5, further comprising the step(s) of:
obtaining, with the contactless POS terminal, instructions for the one or more selected enhancements; and
verifying, with the contactless POS terminal, that the one or more selected enhancements can be executed.

12. The method of claim 5, further comprising the step(s) of:
generating, with the central server, an invoice of the one or more enhancements for a retailer operating the register; and
generating, with the central server, one or more income statements for one or more manufacturers of the one or more products.

13. A point-of-sale product enhancement system comprising:
a register configured for:
identifying one or more products in a package, wherein each of the one or more products has at least one of one or more RFID tags and each of the one or more RFID tags is in at least one of the one or more products,
indicating one or more enhancements available for the one or more products, and
receiving indication of one or more selected enhancements from a customer; and
a contactless POS terminal in communication with the register, with a plurality of antennas and configured for:
receiving one or more product enhancement authorization tokens (one or more PEA tokens) for one or more selected enhancements,
validating the one or more PEA tokens,
receiving the package in a correct placement,
detecting the one or more RFID tags when the package has a correct placement with regards to the contactless POS terminal,
associating each of the RFID tags with an associated product of the one or more products and with an associated antenna of the plurality of antennas, and
executing each of the one or more selected enhancements on the associated product via the associated antenna and an associated RFID tag of the one or more RFID tags.

14. The system of claim 13,
wherein the register is further configured for:
generating the one or more PEA tokens for the selected enhancement, and
transmitting the one or more PEA tokens to the contactless POS terminal.

15. The system of claim 13, further comprising:
a back office server configured for:
generating the one or more PEA tokens for the selected enhancement, and
transmitting the one or more PEA tokens to the contactless POS terminal.

16. The system of claim 13,
wherein the register is further configured for:
adding a charge for the one or more selected enhancements to a bill for the customer; and
recording payment from the customer for the bill.

17. The system of claim 13,
wherein the contactless POS terminal is further configured for:
obtaining instructions for the one or more selected enhancements,
verifying that the one or more selected enhancements can be executed, and
indicating readiness to enhance the one or more products.

18. The system of claim 13,
wherein the contactless POS terminal is further configured for:
generating an audit record of the one or more enhancements of the one or more products; and,
sending the audit record from the contactless POS terminal.

19. The system of claim 18, further comprising:
a central server configured for:
requesting the audit record from the contactless POS terminal,
receiving the audit record from the contactless POS terminal,
generating an invoice of the enhancement for a retailer operating the register, and
generating an income statement for a manufacturer of the product.

20. The system of claim 19,
the central server further configured for:
updating a set of enhancement instructions stored on the contactless POS terminal.
